(19) United States
(12) Patent Application Publication
(10) Pub. No.: US 2026/0085431 A1
(43) Pub. Date: Mar. 26, 2026

(54) ELECTROCHEMICAL PRODUCTION OF HYDROGEN AND LITHIUM HYDROXIDE UNDER DEFINED FLOW CONDITIONS

(71) Applicant: Evonik Operations GmbH, Essen (DE)

(72) Inventors: Christian Hying, Rhede (DE); Elisabeth Gorman, Haltern am See (DE); Patrik Stenner, Hanau (DE); Sabrina Juretzka, Frankfurt am Main (DE); Tobias Stadtmüller, Seligenstadt (DE); Sebastian Arndt, Ginsheim Gustavsburg (DE); Frank Löffler, Heppenheim (DE); Huong Klink-Tran, Mannheim (DE); Jessica Antoni, Nidderau (DE); Nicole Decker, Bochum (DE); Meike Dahlhues, Marl (DE)

(21) Appl. No.: 19/110,778

(22) PCT Filed: Sep. 11, 2023
(86) PCT No.: PCT/EP2023/074927

§ 371 Date: Mar. 11, 2025

(30) Foreign Application Priority Data
Sep. 12, 2022 (EP) 22195072.8

(51) Int. Cl. C25B 1/16; C25B 1/04; C25B 9/15; C25B 9/19; C25B 13/07

(52) U.S. Cl. CPC C25B 1/16; C25B 1/04; C25B 9/15; C25B 9/19; C25B 13/07

(57) ABSTRACT

The problem addressed by the present invention is that of specifying a process for the electrochemical production of LiOH from Li⁺-containing water with the aid of an electrochemical cell with LiSICon membrane that can be operated economically on an industrial scale too. In particular, the process should have good energy efficiency and achieve a high membrane lifetime even when the employed feed contains impurities that are harmful to LiSICon materials. The problem is solved by the flow conditions in the anodic compartment of the electrochemical cell being established such that the anolyte flows along the membrane with a certain minimum crossflow velocity.

For the production of lithium-ion batteries (LIBs), lithium (Li) is by definition necessary. On account of its high reactivity, lithium occurs in nature not as the pure substance, but always in bound form. The starting material used for the production of LIBs is generally lithium in the form of lithium hydroxide (LiOH) or lithium carbonate (Li₂CO₃).

In most natural deposits Li is present in the form of lithium oxide (Li₂O) or salts such as lithium sulfate (Li₂SO₄) or lithium chloride (LiCI). Lithium oxide is a constituent of ores such as pegmatite, while lithium sulfate and lithium chloride are present in dissolved form in the leach liquors of Li salt lakes.

In the course of the mining process, the lithium compound extracted in the particular case is converted into lithium carbonate (Li₂CO₃). In a further process step, the lithium carbonate can be converted into lithium hydroxide by reaction with quicklime or calcium hydroxide. The extraction of Li and its transformation into LiOH is described in:
Wietelmann, U. and Steinbild, M. (2014). Lithium and Lithium Compounds. In Ullmann's Encyclopedia of Industrial Chemistry, (ed.). DOI: 10.1002/14356007.a15_393.pub2

Rich Li deposits are known, but the production of LiOH from the Li compounds they contain is very energy intensive and generates large volumes of wastewater. There is also a strategic need to be free of dependency on the owners of the deposits.

One solution to this problem could be to reprocess the materials from spent LIBs so that the lithium contained therein can be reused as a raw material for new batteries.

Recycling processes for LIBs have already in the past been developed to industrial maturity, but were in most cases aimed at the metals Fe, Ni, Mn, Co, Mg and Al present therein. The alkali metal Li was not generally recovered, since its high reactivity makes it difficult to separate from scrap batteries and it was available at low cost in sufficient amount from natural deposits. The extraction of Li from used LIBs for a long time seemed simply uneconomical.

However, there is now growing social and economic pressure to recover lithium from used LIBs. In order for this idea to come to fruition, it is necessary for recycled Li to be supplied to producers of LIBs in an acceptable quality such that the manufacturing processes for LIBs from recycled Li do not differ from those using mined virgin Li. It goes without saying that there must be no adverse effect on battery quality. Recycled Li, especially in the form of LiOH, must consequently meet very stringent specifications as regards purity. In addition, the process for recovering Li from old batteries must be as energy-efficient as possible. The process should also use little water.

Known processes for recovering lithium from old batteries are collated in:
Pankaj K. Choubey et al.: Advance review on the exploitation of the prominent energy-storage element Lithium. Part II: From sea water and spent lithium ion batteries (LIBs), Minerals Engineering, volume 110, 2017, pages 104-121 DOI: 10.1016/j.mineng.2017.04.008.

A technology that is mentioned only in passing as “LISM” in the above review article is the electrolysis of Li-containing waters with the aid of what are known as LiSICon membranes.

LiSICon stands for lithium super ionic conductor. This is a class of inorganic, (glass-)ceramic material which is electrically insulating, but at the same time has an intrinsic conductivity for Li ions. The transport mechanism for Li derives from the crystal structure of the material. The Li ions are—in simplified terms—“passed through” the crystals. Commercially available LiSICon materials include lithium aluminium titanium phosphate (LATP), lithium aluminium titanium silicon phosphate (LATSP), lithium aluminium germanium phosphate (LAGP) and lithium lanthanum titanium oxide (LLTO). These materials were originally developed as solid-state electrolytes for LIBs. An overview of the transport mechanisms of LiSICons, their crystal structure and production is given in:
Palakkathodi Kammampata et al.: Cruising in ceramics—discovering new structures for all-solid-state batteries—fundamentals, materials, and performances. Ionics 24, 639-660 (2018) DOI: 10.1007/s11581-017-2372-7
Yedukondalu Meesala et al.: Recent Advancements in Li-Ion Conductors for All-Solid-State Li-Ion Batteries. ACS Energy Lett. 2017, 2, 12, 2734-2751 DOI: 10.1021/acsenergylett.7b00849

Specific LiSICon stoichiometries are described by:
Sofia Saffirio et al. Li_{1.4}Al_{0.4}Ge_{0.4}Ti_{1.4}(PO₄)₃ promising NASICON-structured glass-ceramic electrolyte for all-solid-state Li-based batteries: Unravelling the effect of diboron trioxide, Journal of the European Ceramic Society, volume 42, issue 3, 2022, pages 1023-1032 DOI 10.1016/j.jeurceramsoc.2021.11.014.
Eongyu Yi et al. Materials that can replace liquid electrolytes in Li batteries: Superionic conductivities in Li_{1.7}Al_{0.3}Ti_{1.7}Si_{0.4}P_{2.6}O₁₂. Processing combustion synthesized nanopowders to free standing thin films. Journal of Power Sources, volume 269, 2014, pages 577-588, DOI 10.1016/j.jpowsour.2014.07.029.

Their selective conductivity for Li ions means that LiSICon materials can be used as a membrane for separating Li from Li-containing mixtures. The Li must be present in the mixture in ionic form, for instance as an Li salt dissolved in water. The driving force that is needed to push the Li ions through the LiSICon membrane is an electrical voltage. An electrochemical cell comprising two electrodes and an LiSICon membrane that divides the cells into two compartments is constructed for this purpose. In each compartment there is an electrode. The compartments are referred to as anodic or cathodic depending on the polarity of the electrode present in the respective compartment. An electrical voltage is applied to the electrodes and the anionic compartment is filled with the Li-containing water as anolyte. The cathodic compartment is filled with water as catholyte. The membrane passes the Li cations through to the cathode. The water in the cathodic compartment (catholyte) therefore becomes enriched with Li, while the water on the anodic side (anolyte) becomes depleted in Li. Such a process is termed membrane electrolysis.

Membrane electrolysis processes for extracting lithium with the aid of LiSICon membranes have already been described in the prior art.

For instance, Zhen Li et al. describe a process in which the weakly lithium-containing water of the Red Sea is used as a raw material:
Zhen Li et al.: Continuous electrical pumping membrane process for seawater lithium mining. Energy Environ. Sci., 2021, 14, 3152 DOI: 10.1039/d1ee00354b

The Zhen Li research group use LLTO as the membrane. The target product that is separated off is lithium phosphate (Li₃PO₄), which is suitable for the production of lithium iron phosphate (LFP) batteries. LIBs having a different cathode material, for example nickel-manganese-cobalt (NMC) or lithium manganese oxide (NMO), cannot be directly produced therewith

Yang et al. have sought to extract metallic lithium directly from seawater with the aid of solar power, an LAGP membrane and a copper foil.
Sixie Yang et al.: Lithium Metal Extraction from Seawater. Joule, volume 2, issue 9, 2018, pages 1648-1651, DOI 10.1016/j.joule.2018.07.006.

US 2016/0201163 A1 describes the separation of Li ions from a brine such as seawater with the aid of LiSICon membranes. Proposed membrane materials are specifically Li₃N, Li₁₀GeP₂S₁₂, LaₓLi_{y}TiO₂, and Li_{1+x+y}Alₓ(Ti, Ge)₂₋ₓSi_{y}P_{3-y}O₁₂. The target product is lithium carbonate (Li₂CO₃).

WO 2019055730 A1 is likewise concerned with the separation of lithium with the aid of LiSICon membranes. LLTO, LAGP and LATP are specifically mentioned. The LiSICon material can be applied to a support structure. The chemical nature of the support structure is not described in detail. Similarly little is described as to how the application of the LiSICon to the support structure is to be effected. The separated target product is Li ions.

U.S. Pat. No. 9,222,148B2 also discloses the electrolytic separation of lithium hydroxide on an LiSICon membrane and consequent precipitation of lithium hydroxide hydrate.

In addition to the use of ceramic LiSICon membranes, electrolytic processes for the separation of lithium that operate with organic ion-exchange membranes have also been disclosed.

For instance, EP 3805428 A1 describes the electrolytic production of lithium hydroxide. As well as the electrolysis, an electrochemical conversion of the lithium into lithium hydroxide is also operated. To obtain the necessary reactants, water undergoes a simultaneous electrochemical splitting. This is done using a bipolar three-compartment cell with an ion-exchange membrane. The commercially available Asahi® AVV, Nafion® 902, Fumatech® FAB, Fumatech® FKB and Neosepta® CMB ion-exchange membranes are used. The chemical nature of these ion-exchange membranes is not disclosed in EP 3805428 A1, but they will in all likelihood be organic membrane materials. The three-compartment cell operates in acidic media. Used as the feed is water containing Li salts such as lithium sulfate (Li₂SO₄) or lithium chloride (LiCl) in particular. A volume flow through the example cell is specified and the gap size, but not the width of the cell. Flow internals in the cell are not addressed.

A two-stage electrolytic production of lithium hydroxide from aqueous lithium sulfate and/or lithium bisulfate with simultaneous water splitting is disclosed in U.S. Ser. No. 10/036,094 B2. The first stage employs an electrochemical cell having two compartments and the second stage a three-compartment cell. The prevailing pH in the three-compartment cell can be from 8 to 10. The cells are equipped with ion-exchange membranes. The chemical composition of the ion-exchange membranes is not given. The following commercial membranes are mentioned: Fumatech® FAB, Astom® ACM, Asahi® MV, Nafion® 324 and Astom® AHA.

A fundamental drawback of polymer membranes is their permeability to water. This results in dilution of the anolyte with water from the catholyte. In addition, organic ion-exchange membranes are less ion-selective than inorganic LiSICon materials. They allow not just Li⁺, but also Na⁺ to pass through, thereby lowering the purity of the target product when Na is also present in the feed. As well as the purity of the target product, the electricity efficiency of the process also suffers: If the electrolysis is carried out using a non-ion-selective membrane, the transport of unwanted Na⁺ to the second compartment will also consume valuable electrical energy. Moreover, on reaching the second compartment, the Na⁺ is converted into unwanted byproducts by means of unintended electrochemical processes. The energy efficiency of the process based on the yield of the target product Li is reduced. Lastly, these membranes are sensitive to the presence of divalent cations such as Mg⁺⁺ and Ca⁺⁺. Over time these cations poison the membrane, thereby limiting the service life of organic ion-exchange membranes.

The glass-ceramic LiSICon materials promise better ion selectivity. However, the stability of the LiSICon membranes to impurities continues to be a highly significant problem for industrial practice here. For instance, the Li⁺-containing water generated in the reprocessing of used LIBs contains other cations such as Na⁺ and K⁺ in particular, which cause lasting damage to the LiSICon material: These cations appear to occupy the defects in the crystal structure, thereby bringing transport of the Li⁺ cations through the membrane to a virtual standstill. The service life of the electrochemical cell is then expired. The high cost of the LiSICon material means that recycling of Li from LIBs is uneconomical if the service life of the membrane is short. Also, the brine from Li salt lakes has a naturally high sodium content and therefore cannot be allowed to come into contact with known LiSICon membranes. Lithium from salt lakes therefore additionally undergoes an energy-intensive thermal separation and/or a stepwise process using large volumes of water in which it is dissolved and then recrystallized. Although the water can here be evaporated by solar radiation, the water to dissolve the LiCl is scarce in the deserts of South America. This route is thus highly problematic there.

Another practical problem is the high specific electrical resistance of the LiSICon material. This results in the electrochemical cell having a high ohmic internal resistance, which means that the process has a correspondingly high electrical energy requirement. To lower it, the membrane can in theory be made thinner. However, the low thickness of the material would in turn afford it only a short lifetime in aggressive environments.

Based on all the above, the problem addressed by the present invention is that of specifying a process for the electrochemical production of LiOH from Li⁺-containing water with the aid of an LiSICon membrane that can be operated economically on an industrial scale too. In particular, the process should have good energy efficiency and achieve a high membrane lifetime even when the employed feed contains impurities that are harmful to LiSICon materials.

This problem is solved by a process for producing hydrogen and lithium hydroxide, comprising the following steps:
a) providing a feed comprising at least water, Li ions and also impurities, the concentration of Li ions in the feed C_{F} being at least 200 ppm by weight or between 500 ppm by weight and 140 000 ppm by weight, in each case based on the total weight of the feed;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing at least one electrochemical cell, wherein the electrochemical cell has the following properties:
   i. the electrochemical cell includes a first compartment in which an anode is arranged;
   ii. the electrochemical cell includes a second compartment in which a cathode is arranged;
   iii. the electrochemical cell includes a flat-sheet membrane that separates the first compartment from the second compartment, the flat-sheet membrane having the area A;
   iv. the flat-sheet membrane comprises an inorganic material that possesses conductivity for Li ions and that is electrically insulating;
d) providing at least one electrical voltage source that is connected to the anode via a first electrical lead and to the cathode via a second electrical lead;
e) continuous charging of the first compartment with the feed;
f) charging of the second compartment with the poor working medium;
g) charging of the electrochemical cell with an electrical voltage U drawn from the electrical voltage source such that an electrical current/flows between the anode and cathode, the ratio Q of the current strength of the electrical current/and the area A of the flat-sheet membrane being between 100 A/m² and 500 A/m² or between 150 A/m² and 350 A/m²;
h) continuously withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F};
i) withdrawing from the second compartment of a rich working medium comprising water and lithium hydroxide and also of hydrogen, the concentration of lithium hydroxide in the rich working medium C_{M1}, based on the total weight of the rich working medium, being greater than the concentration of lithium hydroxide in the poor working medium C_{M0},
   in which, due to the continuous charging of the first compartment with the feed and due to the continuous withdrawal of wastewater from the first compartment, a first flow develops, which flows through the first compartment along the flat-sheet membrane with a crossflow velocity CFV, the crossflow velocity CFV being greater than 220 mm/s or greater than 350 mm/s or greater than 470 mm/s.

A key aspect of the present invention is that the flow conditions in the first compartment of the electrochemical cell are established such that the anolyte flows along the membrane with a certain minimum crossflow velocity.

The anolyte is the material in the first compartment. The inflow is the feed, the outflow from the first compartment the wastewater. Within the first compartment the anolyte is transformed by electrochemical processes in the cell from the feed into the wastewater.

The crossflow velocity (CFV) is an established operating parameter from membrane technology. It is calculated from the ratio of the volume flow Q through the first compartment and the flow cross section of the first compartment, i.e. the product of the width b of the membrane transversely to the flow direction and the height h of the gap between membrane and anode:

$$CFV = Q / ( {b}^{⋆} h )$$

According to the insights in the present case, the crossflow velocity CFV should be greater than 220 mm/s. A crossflow velocity CFV of greater than 350 mm/s is better and a crossflow velocity CFV of greater than 470 mm/s better still.

The high crossflow velocity may have the effect that the impurities present in the anolyte, which originated from the feed, precipitate on the membrane to a lesser degree and are flushed out again from the first compartment with the wastewater. This means that the impurities cannot clog the membrane, thereby reducing its permeance.

Experimental data confirm that the permeance of the membrane increases as the crossflow velocity rises. The permeance indicates how much mass of lithium per unit membrane area and per unit time is being transported through the membrane. The permeance is thus a measure of the efficiency of the process. It is therefore to be expected that at a higher crossflow velocity the profitability of the process increases.

The crossflow velocity cannot be increased to an indefinitely high level, because increasing turbulence develops in the flow, which increases flow resistance. The consequence of this is that increasing drive power is needed to pump the anolyte through the first compartment.

In order to achieve a good trade-off between the permeance attained and the applied drive performance, it makes sense to cap the crossflow velocity. The crossflow velocity CFV should accordingly be lower than a limit velocity. The attainable limit velocity depends on the setup of the electrochemical cell and its ancillary units and can for example be 600 mm/s or 960 mm/s or 1500 mm/s or 2400 mm/s or 3780 mm/s or 6000 mm/s.

It has surprisingly been found that flow internals such as spacers, as are fitted in spiral-wound modules, can have a negative effect on the permeance of the process. This is surprising, because spacers are routinely used in membrane processes. Therefore, in a preferred development of the invention flow internals such as spacers are dispensed with.

According to the invention, a flat-sheet membrane is used. It has not thus far been possible to realize an electrochemical cell having a hollow-fibre membrane.

The flat-sheet membrane is preferably used in a flat-sheet module. Use in a spiral-wound module is not favoured, because the electrical wiring here has proven to be complicated. Moreover, flow control in spiral-wound modules has been found to be problematic, since in the electrolysis both half-cells must be filled with electrolyte or have electrolyte flowing through them: With a gas separation, which is commonly operated in spiral-wound modules, only the permeate needs to be removed.

It is advantageous when a flow is established not just through the first compartment, but through the second compartment too. Thus, in a further embodiment of the invention, the charging of the second compartment with the poor working medium and the withdrawal of the rich working medium from the second compartment take place continuously, with the result that a second flow develops through the second compartment.

The flow conditions in the second compartment are preferably set up such that the working medium (the catholyte) exhibits laminar flow. The second compartment then has low flow resistance, with the result that little energy is required for the transport of the working medium.

Because of the flow conditions prevailing in the cell, it is possible for the feed to contain impurities that are generally harmful to Li-conducting membrane materials. More particularly, the defined flow conditions at the membrane make it possible to work with a feed that contains one or more of the following anions: sulfate, carbonate, hydroxide and chloride.

In addition to the anions mentioned, the feed may also contain impurities in the form of compounds of the following elements: B, Na, Mg, Al, Si, K, Ca, Mn, Fe, Co, Ni, Cu, C. The listed alkali metals and alkaline earth metals are elements found alongside lithium in natural deposits, while the other metals mentioned are used as conductors or cathode materials in LIBs and are consequently present in feeds obtained from the reprocessing of used LIBs. The carbon originates from organic materials used in LIBs, for instance films, separators, adhesives or sealants.

According to the invention, a membrane is used that includes an inorganic material. The required ion selectivity is thus achieved differently than in the case of polymer membranes. The membrane preferably consists entirely of the inorganic material. Composite membranes that contain the inorganic material solely as a coating on a support material or in which the inorganic material is dispersed in a matrix material of a different type have proved the wrong approach.

The advantage of inorganic membranes over polymer membranes is also founded in their mechanical stiffness: Thus, at higher crossflow velocities inorganic membranes do not oscillate as much as polymer membranes.

In order for the process to work, the inorganic material must conduct Li ions and at the same time act as an electrical insulator.

The specific conductivity a for Li ions should at a temperature of 23° C. be at least 1*10⁻⁵ S/m or at least 5*10⁻⁵ S/m or at least 10*10⁻⁵ S/m and not more than 100*10⁻⁵ S/m. The Li conductivity of the material is measured by impedance spectroscopy. This measurement takes place as follows: The measurement setup comprises two cylindrical electrodes, with the sample arranged therebetween. To ensure optimal contact with the electrodes and reproducible contact pressure, a weight is placed on the sample.

A potentiostat (Zahner-Elektrik I. Zahner-Schiller GmbH & Co. KG, Kronach-Gundelsdorf, Germany) is connected to the electrodes and controlled via the Thales software (Zahner). The measurements are carried out in a frequency range from 1 Hz to 4 MHz and at an amplitude of 5 mV using samples that had been polished and sputtered onto a thin conductive gold layer.

The results of the measurements are presented in the form of Nyquist plots and evaluated using the analysis software (Zahner). The electrical resistance is read at the maximum of the curve of the Nyquist plot. The specific ion conductivity σ [mS/cm] is then calculated using the formula σ=(h·10⁴)/(R·π/4·d²), where h is the height of the sample in mm, R the measured electrical resistance in Ω and d the diameter of the sample in mm.

The specific conductivity for electrons y (electrical conductivity) should at a temperature of 23° C. be less than 10⁻⁷ S/cm (10⁻⁹ S/m) or less than 10⁻¹² S/m or less than 10⁻¹⁶ S/m. From an electron conducting point of view, the inorganic material is therefore classified as a non-conductor.

Preference is given to using an LiSICon as the inorganic material. LiSICon materials are glass-ceramic substances that conduct lithium ions and at the same time act as electrical insulators. All known LiSICon materials can in principle be used as the inorganic material for the purposes of the invention. Known LiSICon materials meet the requirements specified above both for the electrical conductivity and for the ion conductivity of the inorganic material.

For example, the LiSICon material lithium aluminium titanium phosphate (LATP) may be used. Accordingly, in one variant of the invention the inorganic material is a compound of the following stoichiometry:

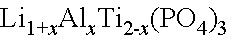

in which: 0.1≤x≤0.3, where preferably x=0.3.

Alternatively, the LiSICon material lithium aluminium germanium phosphate (LAGP) may be used. Accordingly, in one variant of the invention the inorganic material is a compound of the following stoichiometry:

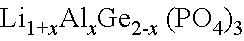

in which: x=0 or x=0.2 or x=0.4.

Alternatively, the LiSICon material lithium aluminium titanium silicon phosphate (LATSP) may be used. Accordingly, in one variant of the invention the inorganic material is a compound of the following stoichiometry:

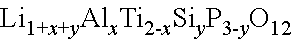

in which: 0.1≤x≤0.3 and 0.2≤y≤0.4.

Particular preference is however given to using an LiSICon that is derived from lithium aluminium germanium phosphate but additionally contains titanium. This is referred to as an LAGTP.

Accordingly, in a preferred variant of the invention the inorganic material is a compound of the following stoichiometry:

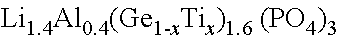

in which: 0≤x≤1.

In a particularly preferred development of the invention, an LATSP that additionally contains germanium is used. This is termed an LAGTSP.

Accordingly, in a particularly preferred variant of the invention the inorganic material is a compound of the following stoichiometry:

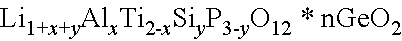

in which: 0≤x≤1 and 0≤y≤1 and 0≤n≤1

A LAGTSP is for example obtainable from Ohara GmbH, Hofheim, Germany under the product name LICGC® AG01.

As an alternative to the phosphates mentioned, the oxidic LiSICon material lithium lanthanum titanium oxide (LLTO) may be used. Accordingly, in one variant of the invention the inorganic material is a compound of the following stoichiometry:

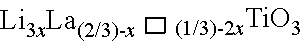

in which: 0≤x≤0.16.

The lithium hydroxide is present in the rich working medium and is withdrawn with this from the second compartment. In order to be able to make use of it, it needs to be separated from the rich working medium. A separation apparatus is provided for this purpose. A preferred development of the invention accordingly includes the following additional process steps:
k) providing a separation apparatus;
l) separating the lithium hydroxide from the rich working medium with the aid of the separation apparatus.

After the lithium hydroxide has been separated from the rich working medium, the working medium can either be disposed of as wastewater or else preferably be reused as poor working medium. For this it is necessary to operate the separation apparatus such that the LiOH is not separated in its entirety, but is instead maintained above the specified minimum concentration cₘ₀ of 50 ppm LiOH. This allows the working medium to be recycled to the second compartment as poor working medium. This then results in recirculation of the working medium between the second compartment and the separation apparatus.

A preferred development of the invention accordingly includes the following additional process steps:
l) separating the lithium hydroxide from the rich working medium with the aid of the separation apparatus so as to afford the poor working medium,
   wherein the step
b) providing a poor working medium comprising water and lithium hydroxide dissolved therein, the concentration of lithium hydroxide in the poor working medium CMO, based on the total weight of the poor working medium, being at least 50 ppm by weight;
   takes place with the aid of the separation apparatus.

In order for recirculation of the working medium between the separation apparatus and the second compartment to be possible, it makes sense for both apparatuses to be installed in the same location. The same location is to be understood as meaning an integrated production facility. The electrochemical cell and separation apparatus are consequently part of an integrated facility.

It is also conceivable for the separation apparatus to be situated away from the electrochemical cell, in a different location. In that case it is however necessary for the working medium to be transported between the cell and the separation apparatus. However, this makes very little sense from an energetic point of view.

Preferably, at least the electrochemical cell is operated continuously both on the anolyte side and on the catholyte side. This means that the charging of the second compartment with the poor working medium and the withdrawal of the rich working medium from the second compartment take place continuously, with the result that a second flow arises through the second compartment. Consequently, there is a constant through-flow in both compartments. The first compartment has a continuous through-flow of feed, resulting in the generation of wastewater, whereas the second compartment has a through-flow of working medium, which flows in as poor working medium and flows out as rich working medium. This makes possible both a higher throughput and the continuous withdrawal of membrane-damaging constituents of the feed and working medium. Continuous operation can therefore be expected to achieve better membrane stability than in batchwise operation on the catholyte side.

In continuous operation too, care must be taken to ensure that the anolyte flow conditions according to the invention are maintained, that is to say that the first flow passes along the membrane with an adequately high crossflow velocity through the first compartment. With regard to the catholyte flow conditions in the second compartment, the aim should however be to achieve laminar flow, since this lowers the flow resistance in the second compartment, which means that less energy is needed to move the working medium. Therefore, in a particular embodiment the second flow is laminar.

### DESCRIPTION OF FIGURES

The invention will now be elucidated in detail with reference to process flow diagrams. In this regard, the figures show:

FIG. 1: shows the functional principle of the simultaneous membrane electrolysis of Li⁺ and water electrolysis in the electrochemical cell with LiSICon membrane;

FIG. 2: shows the functional principle of the recirculation between the electrochemical cell and separation apparatus.

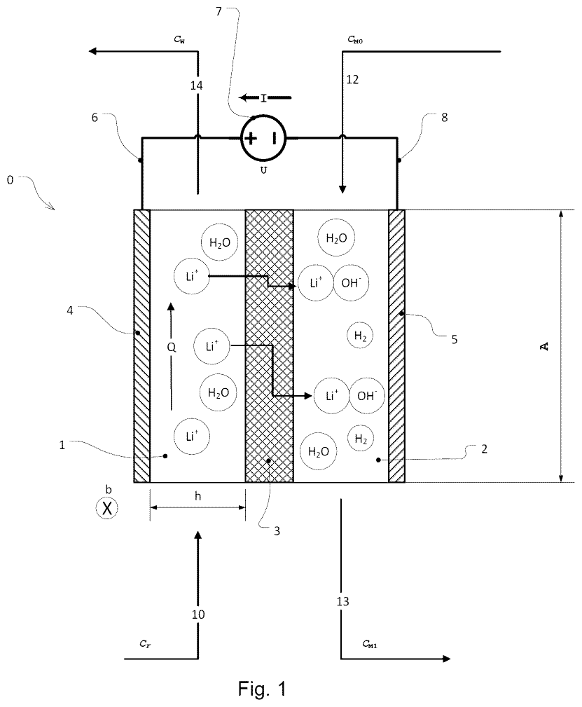

The electrochemical cell 0 necessary for the performance of the process is shown in FIG. 1. It includes a first compartment 1 and a second compartment 2. The two compartments 1 and 2 are separated from one another by a membrane 3. Arranged in the first compartment 1 is an anode 4. Arranged in the second compartment 2 is an cathode 5. The first compartment 1 can therefore be referred to as the anodic compartment and the second compartment 2 as the cathodic compartment.

A first electrical lead 6 connects the anode 4 to a voltage source 7. A second electrical lead 8 connects the cathode 5 to the voltage source 7. The chosen polarity of the voltage source 7 is such that the positive pole of the voltage source 7 is connected to the anode 4 and the negative pole of the voltage source 7 to the cathode 5.

An electric current/flows through the two electrical leads 6 and 8 and via the electrical voltage source 7. Since the membrane 3 acts as an electrical insulator, there is no electrical short circuit between the two electrodes 4 and 5 via the membrane 3.

The membrane 3 is a flat-sheet membrane that consists entirely of an LiSICon material. The anode 4 is a flat metal plate comprising titanium, niobium or tantalum. The cathode 5 is likewise a flat metal plate comprising titanium or nickel. In the simplest case, stainless steel plate is used as the cathode. Anode 4, cathode 5 and membrane 3 have the same shape and may be rectangular or circular. This is not apparent from the side view in FIG. 1. Instead of metal plates, it is also possible to use expanded metals, grids or meshes of the specified materials as electrodes.

The electrochemical cell 0 has an active area A that essentially corresponds to the surface area of the membrane 3, anode 4 and cathode 5. The active area can be reduced in respect of the actual area of electrodes and the membrane by installing sealing elements. The active area is the proportion of the area that is available for the electrochemical process in the cell 0.

During operation, the first compartment 1 is charged with a feed 10. The feed 10 is an aqueous solution containing Li+ ions. From an electrochemical point of view, the feed 10 can be regarded as anolyte.

The feed 10 may be an Li leach liquor from a natural deposit or a material stream arising from the processing of used LIBs. The concentration of Li+ cations in the feed 10 (formula symbol c_{F}) should be at least 200 ppm by weight based on the total mass of the feed. Seawater has a lower Li concentration and must therefore first be concentrated before it is used in the process. The feed 10 also contains anions such as sulfate or chloride. The feed 10 also contains impurities. Anions and impurities are not shown in FIG. 1. The main component of the feed 10 is water H₂O.

The second compartment is charged with a poor working medium 12. The poor working medium 12 is water H₂O having a low concentration C_{M0} of Li+ cations. The concentration c_{M0} is at least 50 ppm by weight based on the total mass of the poor working medium 12. From an electrochemical point of view, the poor working medium 12 can be regarded as catholyte.

The electrochemical cell 0 is also charged with an electrical voltage U drawn from a voltage source 7. This has the following effect:

Firstly, an electrolysis of water takes place in which water (H₂O) is split electrochemically into hydrogen (H₂) and oxygen (O₂). At the cathode 5, OH⁻ and hydrogen are formed. The OH⁻ anions are however unable to cross the membrane 3 and combine with the Li⁺ cations present in the cathodic compartment 2 to form lithium hydroxide (LiOH). Oxygen and H⁺ are formed at the anode 4.

The formation of LiOH in the cathodic compartment 2 is maintained by the migration to the cathode 5 of Li+ cations from the feed 10 driven by the voltage U. They cross the membrane 3 by virtue of the conductivity for Li ions of the membrane and accumulate in the working medium (membrane electrolysis). This results in the formation of a rich working medium 13, which is withdrawn from the second compartment 2. The concentration of Li+ ions in the rich working medium 13 is greater than in the poor working medium 12, thus C_{M1}>C_{M0}.

Thus, a water electrolysis, a membrane electrolysis of Li⁺ and a synthesis of LiOH proceed simultaneously in the electrochemical cell 0.

The simultaneous operation of the Li+ membrane electrolysis and the water electrolysis in the electrochemical cell thus results in the direct formation of lithium hydroxide LiOH and molecular hydrogen H₂. The LiOH is dissolved in water. Part of the hydrogen is dissolved and part is present in gaseous form. The water containing the reaction products LiOH and dissolved H₂ is withdrawn from the cathodic compartment of the cell as rich working medium 13. The gaseous hydrogen H₂ is likewise withdrawn from the second compartment 2.

As a result of the membrane electrolysis the feed 10 becomes depleted in Li+, giving rise to wastewater 14. Thus, c_{W}<C_{F}. The formula symbol c_{W} here represents the concentration of Li ions in the wastewater 14 based on the total mass of the wastewater 14. The formula symbol C_{F} here represents the concentration of Li ions in the feed 10 based on the total mass of the feed 10.

FIG. 1 also shows how the crossflow velocity CFV is determined. This involves measuring the distance between the membrane 3 and the anode 4, i.e. the height h of the gap. In addition, the width b of the membrane 3 is measured transversely to the flow direction. The width b extends in FIG. 1 at right angles to the plane of the drawing. The volume flow Q of the anolyte through the first compartment is then determined.

The crossflow velocity CFV can then be determined as

$$CFV = Q / ( {b}^{⋆} h ) .$$

If the flat-sheet membrane used is not rectangular, an average width must be used. When using a circular cell/membrane, the width b is taken to be ½√2 (approx. 70%) of the maximum width of the channel cross section. The maximum width of the channel cross section is the diameter of the active area A. Consequently, for a circular flat-sheet membrane having a diameter D, the width b is equal to the side length of the square, the perimeter of which has the diameter D of the circular active area A of the cell. Thus,

$$b = \frac{1}{2} √ {2}^{⋆} D .$$

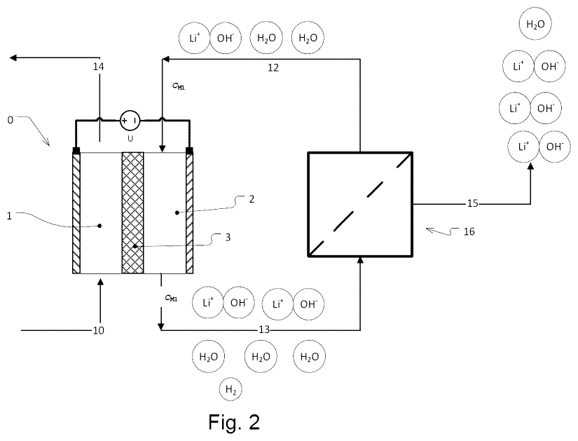

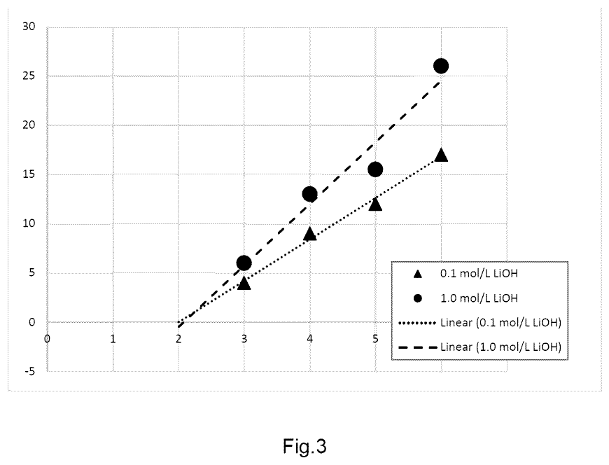

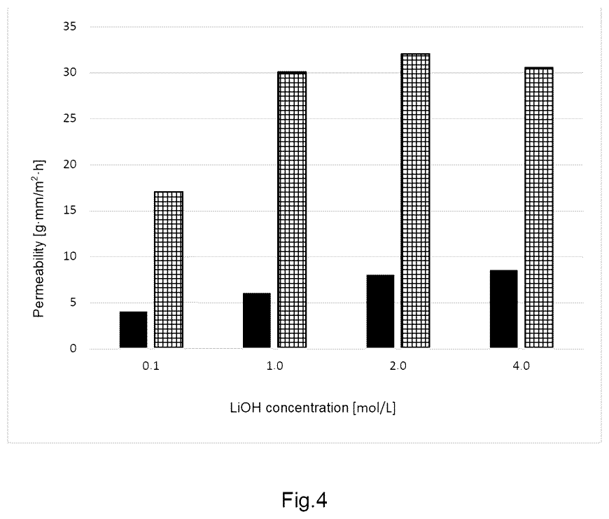

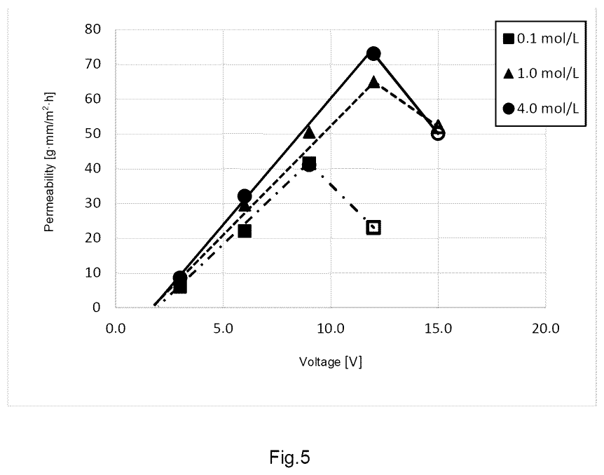

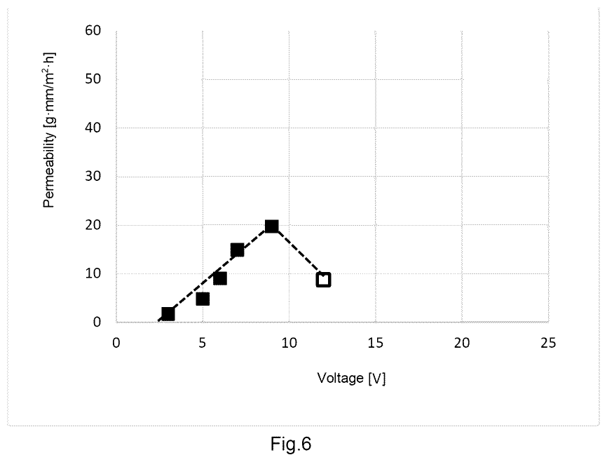

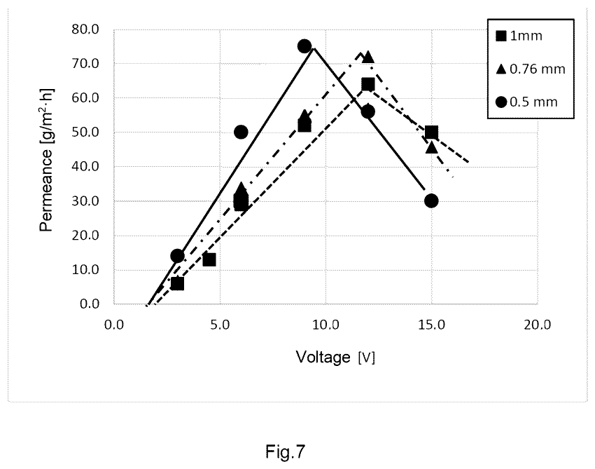

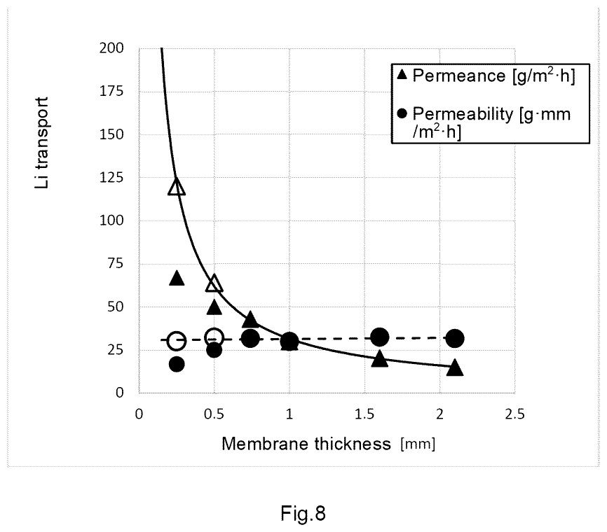

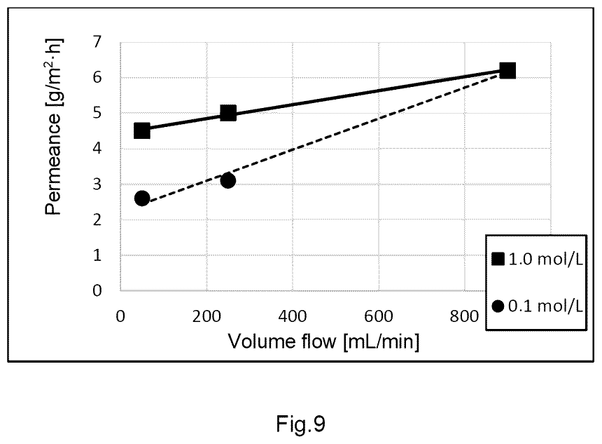

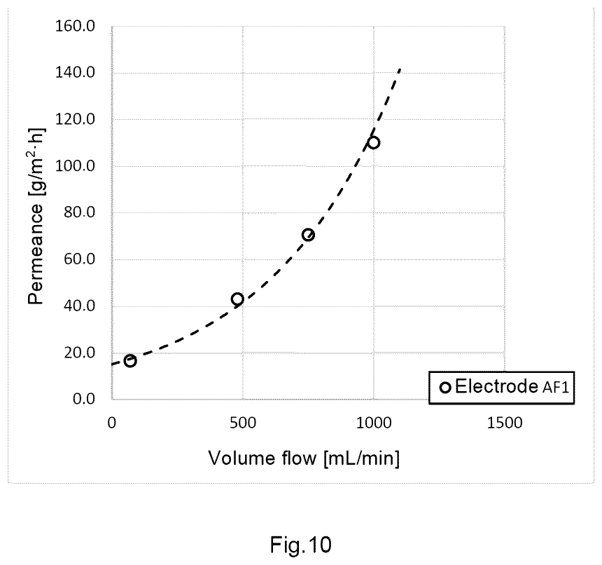

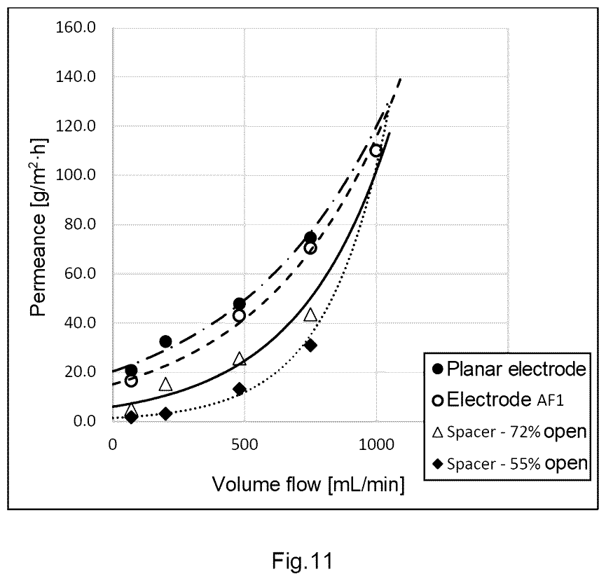

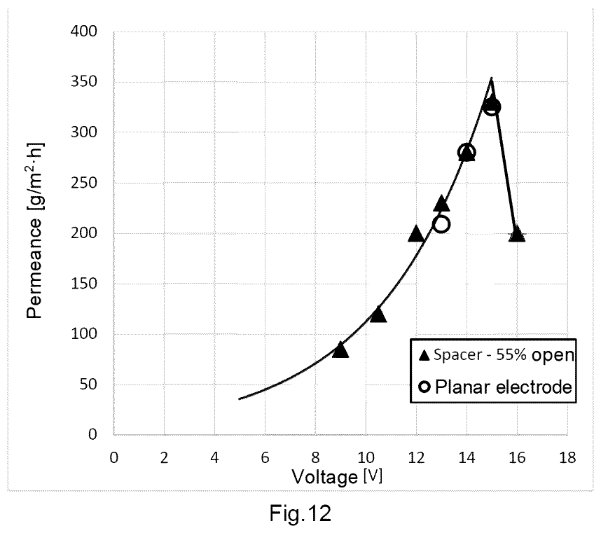

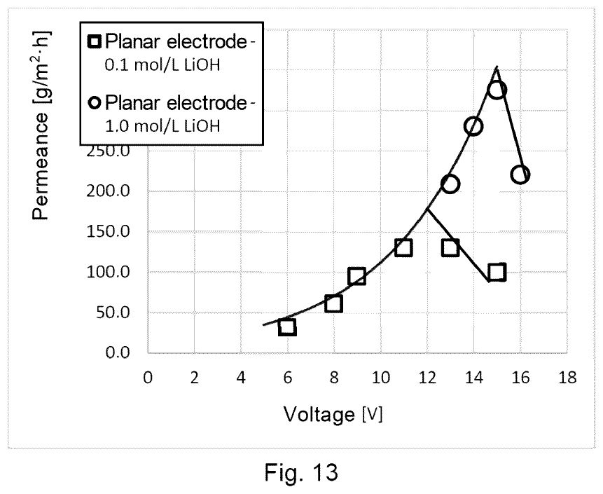

FIG. 2 depicts how the LiOH is extracted as the target product 15 from the rich working medium 13.

For this purpose, a separation apparatus 16 is provided into which the rich working medium 13 is conveyed. The separation apparatus 16 separates from the rich working medium 13 the target product 15, which has a particularly high concentration of LiOH. The target product also contains water and impurities, depending on the desired specification of the target product.

The separation apparatus 16 can be a distillation column or a crystallizer.

The LiOH-depleted output stream from the separation apparatus 16 is recycled as poor working medium 12 to the second compartment 2 of the electrochemical cell 0.

As mentioned previously, the poor working medium 12 needs to have a certain LiOH concentration C_{M0} in order that the process in the electrochemical cell 0 can be initiated in the desired manner by virtue of the low initial resistance. The concentration c_{M0} should be at least 50 ppm by weight based on the total mass of the poor working medium 12. In order to ensure the desired concentration C_{M0}, the separation apparatus 16 is operated such that the not all the LiOH is separated from the rich working medium 13.

In addition to lithium hydroxide LiOH the process also generates H₂. The hydrogen H₂ is dissolved in the rich working medium 13 in part and is withdrawn together with the LiOH from the second compartment 2. In addition, gaseous hydrogen H₂ accumulates in the cell.

Since the hydrogen H₂ is easily degassed from the water, it does not require much effort to remove it from the rich working medium. It is only if the hydrogen H₂ is to be utilized as a second target product that a corresponding second separation apparatus is provided with which the hydrogen is separately obtained in an appropriate quality/purity (not depicted).

The water H₂O, present in the rich working medium 13 is recycled as completely as possible as poor working medium 12. Only the water (of crystallization) present in the target product 15 is lost from the process. This must be replenished in the poor working medium 12 as required (not depicted). The water in the feed 10 does not end up being recirculated between the second compartment 2 and the separation apparatus 16, because the membrane 3 is impermeable to water.

### EXAMPLES

The invention will now be elucidated in detail with reference to experimental descriptions.

### General Experimental Setup and Procedure

For the performance of the electrolysis, the electrolysis cell is first assembled and the anolyte and catholyte containers connected. Care is taken to ensure here that the inflow and return flow are in each case connected on the same side.

In one experiment design, the anode and cathode are both described as planar electrodes. These comprises a titanium plate 19.5 mm in diameter and having a thickness of 1.5 mm, coated on both sides with IrTi mixed oxide, 12 g Ir/m2, from Metakem GmbH, 61250 Usingen, Germany.

The membranes sampled were likewise circular discs having a diameter of about 25 mm. The thickness of the membranes was between 0.3 mm and 2 mm. The material of the tested membranes is specified in the individual examples.

The width b of the membrane transverse to the flow direction was in each case 14 mm. The specified width b is equal to the side length of the square, the perimeter of which has the same diameter as the circular active area A. The gap height h between the anode and the membrane was in each case 2.5 mm. Where spacers were used, the gap height was reduced to 1.8 mm or 1.5 mm.

The electrolysis is blanketed with nitrogen for the entire duration of the process in order to prevent the formation of lithium carbonate. Each cell has a separate anolyte container and separate catholyte container. Each vessel is filled with about 1 kg of liquid, the exact mass is determined by reweighing. The catholyte is always a 5 mmol/L LiOH solution. The anolyte is in each case a lithium salt solution in various concentrations and with various lithium salts.

On switching on the pumps and applying the desired voltage, the experiment commences. The maximum through-flow rate is between 750 mL/min and 1000 mL/min, depending on how the respective experiment was set up. Samples are collected every half hour or at longer intervals if this has been agreed. The first 3 ml of sample collected is discarded. For each sample collected, the power is in each case noted and the conductivity of the sample determined. The samples are then returned to the appropriate container so as to keep the volume virtually constant.

At the end of the experiment, the containers are emptied and all leads and also the membrane are rinsed with demineralized water. The cells are dismantled, the membrane is photographed and SEM images of the catholyte side and anolyte side recorded.

The membrane performance is measured by the parameters permeability (g Li*mm/m²*h) and permeance (g Li/m²*h). The permeance indicates how much mass of lithium per unit membrane area and per unit time is being transported through the membrane. The permeability also takes account of the membrane thickness and thus also makes it possible to compare different membrane types having different thicknesses with one another. For a comprehensive description of the performance both are required, since extremely thin membranes would permit enormously high permeance, but if concentration polarization effects were present in the membrane cell the permeabilities would give an inaccurate picture. Taking account of the membrane thickness would then no longer serve any useful purpose, since transport would not be limited by the membrane.

All measured values shown in the examples are subject to a measurement error of approx.±10% attributable to imprecision in the positioning of the electrodes with respect to one another, in the determinations of the thickness of the membrane samples, and in the determination of the concentration via conductivity measurements.

All ceramics used originated from the manufacturers listed in Table 0 and can be ordered from these sources under the corresponding product names.

TABLE 0
Ceramics used and their manufacturers

| Manufacturer | Product name | Description | Stoichiometry |
|---|---|---|---|
| Ohara GmbH | LICGC ® PW01 | Ohara LiCGC ® | Li_{1.75}Al_{0.6}Ti_{1.4}Si_{0.15}P_{2.85}O₁₂ |
| | | PW01 powder | |
| Ohara GmbH | AG01 | Ohara LiCGC ® | Li₂O-Al₂O₃-SiO₂-P₂O₅-TiO₂- |
| | | AG01 ceramic | GeO₂ |
| Ohara GmbH | SP01 | Ohara LiCGC ® | Li₂O-Al₂O₃-SiO₂-P₂O₅-TiO₂ |
| | | SP01 ceramic | |
| Ampcera ™ (sold by | LiSICon LAGP solid-state | Ampcera LAGP | Li_{1.5}Al_{0.5}Ge_{1.5}(PO₄)₃. |
| MSE Supplies) | electrolyte membrane for | ceramic | |
| | advanced lithium batteries, | | |
| | diameter d = 25.4 mm | | |
| | 0.3 mm thickness | | |

The lithium hydroxide used was analytical grade from Aldrich. All other substances were technical grade.

Unless otherwise stated, LATSP membranes with a thickness of approx. 1 mm (LICGC®, Ohara) were used. The membrane discs were produced by an SPS sintering process at a pressure of 100*10⁵ Pa to 200*10⁵ Pa and a temperature of 950° C. or alternatively were obtained in the appropriate size for the measurement cells directly from various manufacturers (Ohara, Ampcera, Toshima).

### Description of the Sintering Process:

### Sintering by FAST/SPS

The LATSP powder used is sintered by FAST/SPS (field-assisted sintering technology/spark plasma sintering). The sintering was carried out alongside a simultaneous rise in pressure and temperature so as to achieve high compaction and effective sintering in a very short sintering time. The sintering mould assembly consists of a graphite die having an outer diameter of 80 mm, an inner diameter of 36 mm and a height of 55 mm, two graphite half-shells having a wall thickness of 10 mm and the same height, and two graphite punches having a diameter of 25 mm and a height of 30 mm. The half-shells are placed in the die and one punch is introduced into the half-shells from below. Before weighing 2.5 g of the powder into the die onto the lower punch, graphite foil is placed on the punch for better contact. After having weighed in the powder, a second graphite foil is placed on the powder and the upper punch is introduced into the half shells. The die assembly is placed in the furnace chamber of the FAST/SPS furnace between two plates each made of carbon fibre-reinforced graphite. The assembly is contacted via the travel path of the electrodes and the desired pressure is built up. The die is in addition heated by an alternating current, which allows high temperatures to be reached in a short time. After a gradual temperature increase to 250° C. over five minutes, heating is continued at a rate of 130° C./min until reaching a maximum temperature of 900° C., which is held for a further five minutes. During the temperature increase, the pressure is also increased to 43 MPa for five minutes, this pressure likewise being held for five minutes. At the end of the hold time, the contact of the upper electrode is released from the die and the die cools down. The sintered membrane can then be removed from the mould.

### Example 1 (LATSP)

First of all, the voltage dependence of the ceramic membranes during the electrolysis was investigated. The electrolyses were each carried out with 0.1 mol/L LiOH and 1 mol/L LiOH at voltages of 3 V to 6 V, at a volume flow through the electrolysis cell of 600 mL/min. The results of the measurements are shown in Table 1.

In graphical plots of the values, the linear relationship is clear. The point of intersection of the lines with the x axis at approx. 2 V derives from the decomposition voltage of the water and the internal resistances of the cell. This point of intersection is virtually identical for both concentrations. The plot is shown in FIG. 3.

TABLE 1
Voltage dependence of the electrolyses with ceramic membranes

| | |
|---|---|
| | Permeability |
| Voltage | (g Li*mm/m²*h) |

| [V] | 0.1 mol/L | 1 mol/L |
|---|---|---|
| 3 | 4 | 6 |
| 4 | 9 | 13 |
| 5 | 12 | 15.5 |
| 6 | 17 | 26 |

### Example 2 (LATSP)

It was also established that the membrane performance is independent of the anolyte concentration. For this, electrolyses were carried out at voltages of 3 V and 6 V, in each case with an initial charge of respectively 0.1, 1.0, 2.0 or 4.0 mol/L LiOH in the anolyte container, and at an anolyte volume flow through the electrolysis cell of 600 mL/min.

The molar proportions of LiOH correspond to the following proportions by weight of Li:

$$\begin{matrix}0.1 mol / L = 700 ppm Li = 2400 ppm LiOH \\ 1. mol / L = 7000 ppm Li = 24000 ppm LiOH \\ 2. mol / L = 14000 ppm Li = 48000 ppm LiOH \\ 4. mol / L = 28000 ppm Li = 96000 ppm LiOH\end{matrix}$$

The results of the measurements are shown in Table 2. At concentrations of 1 mol/L to 4 mol/L there is no significant measured increase in membrane performance. An LiOH concentration of 0.1 mol/L achieves a slightly lower performance. FIG. 4 shows the results in graph form.

TABLE 2
No dependence on the anolyte concentration

| | |
|---|---|
| | Permeability |
| Concentration | (g Li*mm/m²*h) |

| [mol/L] | 3 V | 6 V |
|---|---|---|
| 0.1 | 4 | 17 |
| 1 | 6 | 30 |
| 2 | 8 | 32 |
| 4 | 8.5 | 30.5 |

### Example 3 (LATSP)

From the results of the experiments in examples 1 and 2 it can be seen that the permeability of lithium through the ceramic ion-conducting membrane is concentration-dependent, even though the driving force for the process is the applied voltage difference. For a better description of this behaviour, additional experiments were carried out. These were also carried out in a range with larger voltages, between 3 V and 15 V. The volume flow through the anolyte compartment of the cell was 600 mL/min and anolyte concentrations of 0.1 mol/L LiOH, 1.0 mol/L LiOH and 4.0 mol/L LiOH were used.

The results of the investigation are summarized in Table 3.

TABLE 3
Permeability as a function of voltage for LATSP

| | Permeability | | |
|---|---|---|---|
| Voltage | [g · mm/m² · h] | | |
| [V] | 0.1 mol/L | 1.0 mol/L | 4.0 mol/L |
| 3.0 | 6 | 6 | 8.5 |
| 6.0 | 22 | 29.5 | 32 |
| 9.0 | 41.5 | 50.5 | 41 |
| 12.0 | 23 | 65 | 73 |
| 15.0 | | 52 | 50 |

FIG. 5 shows the results in graph form.

From a certain voltage, above 9 volts, the permeability through the LATSP membrane used does not rise any further, but instead falls markedly. Since this limit appears to be reached for the 0.1 mol/L LiOH solution as anolyte at relatively low voltages and relatively low permeabilities, it was concluded that above this limit there is a ceiling on lithium transport caused by inadequately rapid transport of lithium at the membrane surface on the anolyte-facing side.

### Example 4 (LAGP)

Repeating example 3 with a different ceramic ion-conducting material (LAGP) having a material thickness of 0.3 mm, an anolyte concentration of 0.1 mol/L LiOH and an anolyte volume flow through the electrolysis cell of 600 mL/min shows a similar picture. Here too it is not possible above a certain limit to achieve a further rise in permeability by increasing the voltage.

The results are summarized in Table 4.

TABLE 4
Permeability as a function of voltage for LAGP

| LAGP | |
|---|---|
| Voltage | Permeability |
| [V] | [g · mm/m² · h] |
| 3 | 1.7 |
| 5 | 4.8 |
| 6 | 9 |
| 7 | 14.9 |
| 9 | 19.7 |
| 12 | 8.7 |

FIG. 6 shows the results in graph form.

### Example 5 (LATSP)

A series of experiments with 1.0 mol/L LiOH in the anolyte and a volume flow of 600 mL/min and membranes of varying thickness shows, when looking at permeance, that the cause is in the limited transport of lithium ions to the surface of the anolyte-side membrane surface. The region above which a rise is no longer possible is in all experiment series in the range from 60 to 75 g/m²·h.

Thus, with the given experimental setup it is above said limit not possible to increase lithium transport by increasing the voltage difference.

The results are summarized in Table 5.

TABLE 5
Permeance as a function of voltage for LATSP

| | Permeance | | |
|---|---|---|---|
| Voltage | [g/m² · h] | | |
| [V] | 1 mm | 0.76 mm | 0.5 mm |
| 3.0 | 6.0 | 6.7 | 14.0 |
| 4.5 | 13.0 | | |
| 6.0 | 29.0 | 33.9 | 50.0 |
| 6.0 | 30.0 | | |
| 9.0 | 52.0 | 54.6 | 75.0 |
| 12.0 | 64.0 | 56.8 | 56.0 |
| 15.0 | 50.0 | 45.7 | 30.0 |

FIG. 7 shows the results in graph form.

### Example 6 (LATSP)

A series of experiments at 6 V with 1.0 mol/L LiOH in the anolyte and a volume flow of 600 mL/min and membranes of varying thickness shows, when looking at permeance and permeability, that up to a membrane thickness of 0.75 mm these show the expected relationships to one another via the membrane thickness. With thinner membranes both deviate towards lower values from the expected behaviour indicated in FIG. 8 as extrapolated values (unfilled symbols). The values are shown in Table 6.

TABLE 6
Permeance and permeability as a function of membrane thickness

| Membrane | | | |
|---|---|---|---|
| thickness | Permeance | Permeability | |
| [mm] | [g/m² · h] | [g · mm/m² · h] | Comments |
| 2.10 | 15 | 32 | |
| 1.60 | 20 | 32 | |
| 1.00 | 30 | 30 | |
| 0.74 | 43 | 32 | |
| 0.50 | 50 | 25 | |
| 0.25 | 67 | 17 | |
| 0.50 | 64 | 32 | Extrapolated expected |
| | | | value |
| 0.25 | 120 | 32 | Extrapolated expected |
| | | | value |

FIG. 8 shows the results in graph form.

The various examples 1 to 6 show that a technically desirable high permeance for lithium cannot be achieved by a thin membrane or a high voltage alone and also not through the selection of a ceramic having the best-possible Li conductivity, but that further measures need to be taken in order to realise this.

### Example 7 (LATSP)

In electrolysis experiments with a 0.1 mol/L and 1.0 mol/L LiOH solution as anolyte at a voltage of 3 V and various volume flows, lithium transport through the membrane had previously been observed to be dependent on the volume flow, i.e. thus also on the crossflow velocity, even at low permeances.

The results are collated in Table 7.

TABLE 7
Dependence of permeance on volume flow for LATSP

| Concentration | Volume flow | Permeance |
|---|---|---|
| [mol/L LiOH] | [mL/min] | [g/m² · h] |
| 1 | 50 | 4.5 |
| 1 | 250 | 5 |
| 1 | 900 | 6.2 |
| 0.1 | 50 | 2.6 |
| 0.1 | 250 | 3.1 |
| 0.1 | 900 | 6.2 |

FIG. 9 shows the results in graph form.

### Example 9 (LAGP)

These results suggest that, surprisingly, the passage of lithium from the flow to the membrane surface has a significant influence on the overall performance of the process even at very low voltages and permeances. The passage to the surface is governed by the crossflow velocity at the membrane surface and thus by the volume flow passing through the anolyte cell.

A further increase in volume flow at a voltage of 6 V and an anolyte concentration of 1.0 mol/L LiOH showed that this allowed lithium transport (permeance) to be increased beyond the previously observed limit, to more than 110 g_{Li}/m²·h.

The results are collated in Table 8.

TABLE 8
Dependence of permeance on volume flow for LAGP

| Concentration | Volume flow | Permeance |
|---|---|---|
| [mol/L LiOH] | [mL/min] | [g/m² · h] |
| 1 | 750 | 71 |
| 1 | 500 | 50 |
| 1 | 200 | 38 |
| 1 | 70 | 24 |
| 1 | 1000 | 111 |

FIG. 10 shows the results in graph form.

### Example 10 (LAGP)

A further increase in volume flow at a voltage of 6 V and an anolyte concentration of 1.0 mol/L LiOH could not be realized with the apparatus setup. Therefore, as a further measure the use of alternative electrode geometries and spacer materials was examined.

The spacers can be obtained from the following companies:
Fine spacer (72% open)
SWM; 601 Industrial Drive, Middletown, DE 19709, USA
Type Naltex N02016_90PP
Coarse spacer (55% open)
Intermas Nets S.A.
Ronda Collsabadell, 11, 08450 Llinars del Valles (Barcelona), Spain

The fitting of the fine spacer brings about a reduction in gap height from 2.5 mm to 1.8 mm, while the coarse spacer reduces the gap height to 1.5 mm. The membrane width of 14 mm remains unchanged by the fitting of the spacer.

The results of the investigations with a volume flow of 70 to 750 mL/min, 6 V and a 1 mol/L LiOH solution are shown in Table 9.

In all arrangements an increase in volume flow resulted in an increase in lithium transport through the membrane. From the results it can be seen that, at a voltage of 6 V, transport is dependent on the electrode area and on the openly accessible area of the membrane (area not covered by the bars of the spacer). An increase in permeance resulting from the introduction of spacers, the purpose of which is to ensure greater mixing of the feed volume flow, is not discernible.

The trend in the permeances suggests that, at a volume flow in the anolyte compartment of approx. 1000 mL/min and above, these converge in all process types. It can therefore be assumed that above this volume flow it is solely transport through the ceramic lithium-ion-conducting membrane that is rate determining.

TABLE 9
Influence of the spacer on crossflow velocity and permeance

| | | | Volume | | Crossflow |
|---|---|---|---|---|---|
| | Width | Height | flow | Permeance | velocity |
| Electrode/spacer | [mm] | [mm] | [mL/min] | [g/m² · h] | [mm/s] |
| Planar electrode | 14 | 2.5 | 70 | 20.8 | 33.3 |
| Planar electrode | 14 | 2.5 | 200 | 32.5 | 95.2 |
| Planar electrode | 14 | 2.5 | 480 | 47.8 | 228.6 |
| Planar electrode | 14 | 2.5 | 750 | 74.7 | 357.1 |
| Electrode AF1 | 14 | 2.5 | 70 | 16.5 | 33.3 |
| Electrode AF1 | 14 | 2.5 | 480 | 43 | 228.6 |
| Electrode AF1 | 14 | 2.5 | 750 | 70.5 | 357.1 |
| Electrode AF1 | 14 | 2.5 | 1000 | 110 | 476.2 |
| AF1/spacer 72% open | 14 | 1.8 | 70 | 5.1 | 46.3 |
| AF1/spacer 72% open | 14 | 1.8 | 200 | 15.3 | 132.3 |
| AF1/spacer 72% open | 14 | 1.8 | 480 | 25.7 | 317.5 |
| AF1/spacer 72% open | 14 | 1.8 | 750 | 43.6 | 496.0 |
| AF1/spacer 55% open | 14 | 1.5 | 70 | 1.7 | 55.6 |
| AF1/spacer 55% open | 14 | 1.5 | 200 | 3.2 | 158.7 |
| AF1/spacer 55% open | 14 | 1.5 | 480 | 13.2 | 381.0 |
| AF1/spacer 55% open | 14 | 1.5 | 750 | 31 | 595.2 |

FIG. 11 shows a plot of the measured permeances against the volume flows.

### Example 11 (LAGP)

At a volume flow of 1000 mL/min, the voltage was increased in stages. In this experiment, the employed coarse spacer geometry (55% open) was found to ensure thorough mixing of the feed containing 1.0 mol/L LiOH, up to the point that increasing the voltage achieved a permeance of more than 300 g_{Li}/m²·h at 15 V, above which even higher voltages result in the known fall in permeance.

A run seeking to achieve this at the same volume flow using a planar electrode without spacers gave similar results at the investigated high voltages.

FIG. 12 shows the permeances as function of voltage with spacer (▴) and without spacer (◯). The values are presented in Table 10.

TABLE 10
Influence of the spacer and of the voltage on permeance

| | | Volume | |
|---|---|---|---|
| | Voltage | flow | Permeance |
| Electrode/spacer | [V] | [mL/min] | [g/m² · h] |
| Planar electrode | 6 | 70 | 20.8 |
| Planar electrode | 6 | 200 | 32.5 |
| Planar electrode | 6 | 480 | 47.8 |
| Planar electrode | 6 | 750 | 74.7 |
| Planar electrode | 13 | 1000 | 209 |
| Planar electrode | 14 | 1000 | 280 |
| Planar electrode | 15 | 1000 | 325 |
| Planar electrode | 16 | 1000 | 220 |
| AF1/spacer 55% open | 6 | 750 | 31.0 |
| AF1/spacer 55% open | 9 | 1000 | 85 |
| AF1/spacer 55% open | 10.5 | 1000 | 120 |
| AF1/spacer 55% open | 12 | 1000 | 200 |
| AF1/spacer 55% open | 13 | 1000 | 230 |
| AF1/spacer 55% open | 14 | 1000 | 280 |
| AF1/spacer 55% open | 15 | 1000 | 330 |
| AF1/spacer 55% open | 16 | 1000 | 200 |

It was hereby shown that establishing the highest possible crossflow velocity/volume flow allows the permeance of LiSICon membranes used in membrane electrolysis to be significantly increased to an extent such that economic use becomes possible. Surprisingly, spacers, as are typically used in membrane electrolyses between polymeric ion-exchange membrane end electrode, are not necessary, since ceramic membranes when used are dimensionally stable and thus keep a defined flow channel open. The use of spacers in combination with ceramic membranes is then somewhat less preferable, since the bars of the polymer spacers block part of the exchange area.

### Example 12 (LAGP)

Repeating experiment 11 just with an anolyte solution having a concentration of 0.1 mol/L LiOH led when using a planar electrode to the results shown in Table 11 and in FIG. 13 indicated by the “□” data points.

TABLE 11
Influence of voltage on permeance

| Voltage | Volume flow | Permeance |
|---|---|---|
| [V] | [mL/min] | [g/m² · h] |
| 6 | 1000 | 32.0 |
| 8 | 1000 | 61.0 |
| 9 | 1000 | 95.0 |
| 11 | 1000 | 130.0 |
| 13 | 1000 | 130 |
| 15 | 1000 | 100 |

In this case too, the permeance can be increased by increasing the voltage. However, as shown previously in example 11, above a certain limit it is not possible to achieve any further increase in permeability and increasing the voltage further results in a decline in permeance. The permeance limit is lower than when using a 1.0 mol/L solution as shown in example 11 (cf. “O” data points), but is more than twice as high as in comparable experiments with lower crossflow velocity.

It was hereby confirmed that establishing the highest possible crossflow velocity/volume flow allows the permeance of LiSICon membranes used in membrane electrolysis to be significantly increased to an extent such that economic use becomes possible.

### LIST OF REFERENCE SYMBOLS

0 Electrochemical cell
1 First compartment
2 Second compartment
3 Membrane
4 Anode
5 Cathode
6 First electrical lead
7 Voltage source
8 Second electrical lead
9 Not assigned
10 Feed
11 Not assigned
12 Poor working medium
13 Rich working medium
14 Wastewater
15 Target product
16 Separation apparatus
H₂O water
H₂ Hydrogen
O₂ Oxygen
LiOH Lithium hydroxide
OH⁻ OH anions
Li⁺ Lithium cations
U Electrical voltage
I Electric current
A Active area
C_{F} LiOH concentration in feed
C_{W} LiOH concentration in wastewater
C_{M0} LiOH concentration in poor working medium
C_{M1} LiOH concentration in rich working medium
b Width of the membrane transversely to the flow direction
h Height of the gap between membrane and anode
Q Volume flow through the first compartment
CFV Crossflow velocity

1. Process for producing hydrogen and lithium hydroxide, comprising the following steps:
a) providing a feed comprising at least water, Li ions and also impurities, the concentration of Li ions in the feed C_{F} being at least 200 ppm by weight or between 500 ppm by weight and 140 000 ppm by weight, in each case based on the total weight of the feed;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing at least one electrochemical cell, wherein the electrochemical cell has the following properties:
v. the electrochemical cell includes a first compartment in which an anode is arranged;
vi. the electrochemical cell includes a second compartment in which a cathode is arranged;
vii. the electrochemical cell includes a flat-sheet membrane that separates the first compartment from the second compartment, the flat-sheet membrane having the area A;
viii. the flat-sheet membrane comprises an inorganic material that possesses conductivity for Li ions and that is electrically insulating;
d) providing at least one electrical voltage source that is connected to the anode via a first electrical lead and to the cathode via a second electrical lead;
e) continuous charging of the first compartment with the feed;
f) charging of the second compartment with the poor working medium;
g) charging of the electrochemical cell with an electrical voltage U drawn from the electrical voltage source such that an electrical current/flows between the anode and cathode, the ratio Q of the current strength of the electrical current/and the area A of the flat-sheet membrane being between 100 A/m² and 500 A/m² or between 150 A/m² and 350 A/m²;
h) continuously withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F};
i) withdrawing from the second compartment of a rich working medium comprising water and lithium hydroxide and also of hydrogen, the concentration of lithium hydroxide in the rich working medium C_{M1}, based on the total weight of the rich working medium, being greater than the concentration of lithium hydroxide in the poor working medium C_{M0},
wherein, due to the continuous charging of the first compartment with the feed and due to the continuous withdrawal of wastewater from the first compartment, a first flow develops, which flows through the first compartment along the flat-sheet membrane with a crossflow velocity CFV, the crossflow velocity CFV being greater than 220 mm/s or greater than 350 mm/s or greater than 470 mm/s.

2. Process according to claim 1, wherein the crossflow velocity CFV is lower than a limit velocity, the limit velocity being selected from the group consisting of the following limit velocities: 600 mm/s, 960 mm/s, 1500 mm/s, 2400 mm/s, 3780 mm/s and 6000 mm/s.

3. Process according to claim 1, wherein the first compartment is free of flow internals.

4. Process according to claim 3, wherein the first compartment is free of spacers.

5. Process according to claim 1, wherein the flat-sheet membrane is fitted in a flat-sheet module.

6. Process according to claim 1, wherein the feed contains anions selected from the group consisting of sulfate, carbonate, hydroxide and chloride.

7. Process according to claim 1, wherein the feed contains impurities in the form of compounds of elements selected from the group consisting of B, Na, Mg, Al, Si, K, Ca, Mn, Fe, Co, Ni, Cu and C.

8. Process according to claim 1, wherein the inorganic material present in the flat-sheet membrane possesses a conductivity for Li ions, measured by the “impedance spectroscopy” method described herein, that at a temperature of 23° C. is at least 1*10⁻⁵ S/m or at least 5*10⁻⁵ S/m or at least 10*10⁻⁵ S/m and not more than 100*10⁻⁵ S/m.

9. Process according to claim 8, wherein the inorganic material is a compound of the following stoichiometry (LATP): 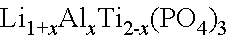
in which: 0.1≤x≤0.3, where preferably x=0.3.

10. Process according to claim 8, wherein the inorganic material is a compound of the following stoichiometry (LATSP): 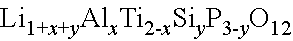
in which: 0.1≤x≤0.3 and 0.2≤y≤0.4.

11. Process according to claim 8, wherein the inorganic material is a compound of the following stoichiometry (LAGTSP): 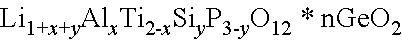
in which: 0≤x≤1 and 0≤y≤1 and 0≤n≤1

12. Process according to claim 8, wherein the inorganic material is a compound of the following stoichiometry (LAGTP): 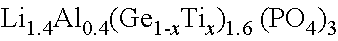
in which: 0≤x≤1.

13. Process according to claim 8, wherein the inorganic material is a compound of the following stoichiometry (LAGP): 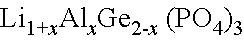
in which: x=0 or x=0.2 or x=0.4.

14. Process according to claim 8, wherein the inorganic material is a compound of the following stoichiometry (LLTO): 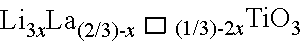
in which: 0≤x≤0.16.

15. Process according to claim 9, wherein the flat-sheet membrane consists entirely of the inorganic material.
